(19) United States
(12) Patent Application Publication
(10) Pub. No.: US 2011/0047385 A1
(43) Pub. Date: Feb. 24, 2011

(54) Methods and Systems for Digitally Signing a Document

(76) Inventor: Hershel Kleinberg, Alexandria, VA (US)

Correspondence Address: COOLEY LLP;ATTN: Patent Group, Suite 1100, 777 - 6th Street, NW, WASHINGTON, DC, 20001, US

(21) Appl. No.: 12/708,300

(22) Filed: Feb. 18, 2010

Related U.S. Application Data
(60) Provisional application No. 61/236,404, filed on Aug. 24, 2009.

(51) Int. Cl. H04L 9/32

(52) U.S. Cl. 713/176

(57) ABSTRACT

Methods and systems according to various embodiments provide a voice-based digital signature to a digital document. For example, a user can access a website to fill in or compete a digital document such as an insurance application (e.g., an application for Medicare supplement insurance), and can call an interactive voice response (“IVR”) system to provide a voice-based (or oral or aural) digital signature to the digital document. The digital signature can then be attached, related, or appended to that digital document in place of a traditional signature. Thus, the digital document need not be printed and sent to the user for a signature.

### CROSS-REFERENCE TO RELATED APPLICATIONS

This application claims priority to U.S. Provisional Patent Application Ser. No. 61/236,404, entitled “Methods and Systems for Digitally Signing a Document,” filed Aug. 24, 2009, the disclosure of which is hereby incorporated by reference in its entirety.

### BACKGROUND

The disclosed embodiments relate generally to digitally signing documents including, for example, digital documents.

### SUMMARY

Methods and systems according to various embodiments provide a voice-based digital signature to a digital document. For example, a user can access a website to fill in or compete a digital document such as an insurance application (e.g., an application for Medicare supplement insurance), and can call an interactive voice response (“IVR”) system to provide a voice-based (or oral or aural) digital signature to the digital document. The digital signature can then be attached, related, or appended to that digital document in place of a traditional signature. Thus, the digital document need not be printed and sent to the user for a signature.

### BRIEF DESCRIPTION OF THE DRAWINGS

FIG. 1 is a flow chart of a process for storing data related to a digital document and providing access to a digital signature module related to the digital document, according to an embodiment.

FIG. 2 is a flow chart of a process for defining a digital signature related to a digital document, according to an embodiment.

FIG. 3 is a flow chart of a process for digitally signing a digital document, according to an embodiment.

FIG. 4 is a schematic block diagram of a system for accessing and digitally signing a digital document, according to an embodiment.

FIG. 5 is a schematic block diagram of another system for accessing and digitally signing a digital document, according to an embodiment.

### DETAILED DESCRIPTION

A digital document can be, for example, any digital representation of a document or form. Some digital documents can include data fields or portions that can be filled in or completed. Such digital documents can be stored at memories of computing devices such as computer servers or web servers. In some embodiments, the data fields of a digital document can be populated (or filled in) with data using a word processing application, an Internet browser, or some other software module configured to interpret digital documents. For example, a digital document can be a file used with a word processor, an extensible markup language (“XML”) document, a portable document format (“PDF”) document, or a flat or structured digital file.

In one embodiment, a website is provided (e.g., by a web server) for completing insurance forms and/or applications. Insurance forms and/or applications can be related to various types or classes of insurance such as Medicare related insurance products which can include, for example, Medicare supplement plans, Medicare Advantage plans, Medicare Plus Choice plans, and/or Medicare Part D plans. A user can access the website using, for example, an Internet browser. The website can provide various functionalities (e.g., user authentication, management of digital documents, instructions, etc.), including the ability for the user to review basic materials regarding insurance such as Medicare supplement insurance forms or applications and/or insurance forms and/or applications for Medicare solutions and request (or generate) an initial quote for insurance.

If the user is satisfied with the quote, the user can indicate (e.g., by clicking a mouse on a button or icon at a webpage of the website) to activate a webpage providing access to various digital documents including the insurance application. The digital insurance application can be, for example, a state-approved application (e.g., for Medicare supplement insurance) in a portable document format (“PDF”) document. The user can fill in the state-approved PDF application online via a webpage and the Internet browser. In some embodiments, the user can also save the digital insurance application and later return to compete it, or to call a moderator or agent for assistance on its completion. When the user indicates the application is completed, the data is validated (or verified) and if missing or incorrect, the user has the ability to complete or correct the application. In some embodiments, a webpage can inform the user of which portions of the digital insurance application (e.g., which data fields) are incomplete. At any time, the user can call (e.g., using a telephone or a textual chat) a moderator or agent for assistance with the digital insurance application.

After the application is completed and validated, the user is given access information associated with a digital signature module (such as a telephone number) and a digital document identifier related to the insurance application. For example, a webpage can be presented to the user with a telephone number and an alphanumeric digital document identifier of the insurance application. The user can call the phone number and interact with an IVR system (or a live operator) to enter the digital document identifier and, in some embodiments, respond to a number of automated questions in order to create a digital signature using the IVR system. For example, the user can state his or her name, age, and address, and provide vocal assent to the terms of the insurance application. The user can also provide non-spoken responses, such as pressing one or more keys on a telephone handset. The IVR system can record the user's spoken and/or non-spoken responses, and the recorded responses can define the digital signature. Furthermore, the IVR system can ask questions and record related responses regarding health of the user and/or other questions relevant to underwriting, and/or confirm prior responses. The digital document (e.g., the insurance application) and the digital signature can then be provided or sent to an insurance carrier on, for example, a nightly basis.

Additionally, payment information can be collected during the initial application process, during the insurance application validation process, or during the digital signature process. For example, the user can be asked to provide a credit card number, electronic funds transfer number, and/or bank routing information.

Methods and systems described herein provide many advantages over other digital document completion and digital signing methods. For example, digital voice signatures can be easier to tie to or associate with a specific individual than some other technologies. Additionally, voice signature can be simpler to use for certain demographic groups (such as the senior community).

Additionally, methods and systems described herein can be applicable to diverse digital documents defined or organized by third parties. Because the document itself can be presented to a user for completion, the underlying system can be agnostic to the data fields of the document. In some embodiments, a digital document can include metadata or instructions related to validating or verifying that digital document.

Similarly, methods and systems disclosed herein can simplify testing and/or assurance for compliance with federal and/or state laws and regulations. For example, because methods and systems can use pre-approved digital documents, these methods and systems utilize state-approved forms without modification.

In some embodiments, users can be directed to a website by links or references included in, for example, electronic mail (“email”) messages and/or other websites or webpages. Information related to the referring link (e.g., an entity controlling a webpage or providing an email message) can be tracked and stored to provide compensation for referrals.

In some embodiments, the system can be used directly by consumers or through interaction with a call center agent. In other words, the IVR system at the end of the application process can be different based on whether the document was filled in personally by a customer (or user) or by a call center agent. If the application can be filled in by an agent, the IVR system can ask, “Have you reviewed the application sent to you by agent Smith? Did you receive a copy of the Outline of Coverage by email?” other relevant questions. However, if the application was filled in personally, the IVR system can ask, “Did you fill in and review your answers on the application? Were you able to review and download a copy of the outline of coverage?” Additionally, the call center agent can be able to participate and assist in the call back process. In other words, the call center agent can remain on a telephone call with the customer while the customer interacts with the IVR system to provide a digital signature. For example, the call center agent can call into a digital signature module (e.g., an IVR system) on behalf of the consumer and conference the customer in to complete the digital signature process at the end of the sales call.

As used in this specification, the singular forms “a,” “an” and “the” include plural referents unless the context clearly dictates otherwise. Thus, for example, the term “a computer server” is intended to mean a single computer server or a combination of computer servers, “a digital signature” is intended to mean one or more digital signatures, or a combination thereof.

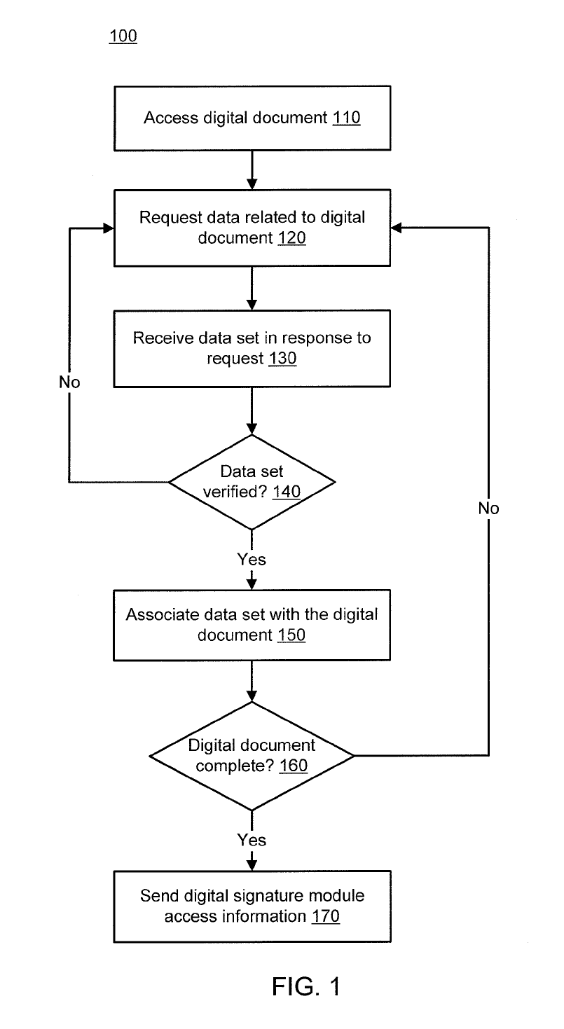

FIG. 1 is a flow chart of a process for storing data related to a digital document and providing access to a digital signature module related to the digital document, according to an embodiment. Process 100 can be implemented, for example, as a software module (e.g., source code, object code, one or more scripts, or instructions) stored at a memory and operable to be executed and/or interpreted or compiled at a processor operatively coupled to the memory at a computing device. For example, processor-executable instructions stored at a memory of a computing device can be executed at a processor at the computing device to cause the processor to execute the steps of process 100. In some embodiments, process 100 can be implemented as one or more hardware modules such as, for example, an application-specific integrated circuit (“ASIC”), a field-programmable gate array (“FPGA”), a processor, or other hardware module at a computing device. In some embodiments, process 100 can be implemented as a combination of one or more hardware modules and software modules at a computing device.

A digital document is accessed, at 110. For example, a digital document can be retrieved from a storage device such as a local hard disk (or drive), a file server, a network attached storage (“NAS”), a storage area network (“SAN”), or some other storage device, and stored at a memory (e.g., of a computer server including a processor configured to implement process 100 such that the digital document is accessible to the computer server). In some embodiments, the digital document can be parsed or analyzed to determine whether the digital document includes any data fields that can be filled or completed with additional data.

Data related to the digital document can be requested, at 120. For example, a computer server implementing process 100 can request data related to the digital document such as a name of a person with whom the digital document is associated can be requested via a webpage or other interface provided via a communications network (e.g., the Internet). A user of the webpage can input a data set (e.g., a name) related to the requested data at the webpage using an Internet browser application executing on a computing device (e.g., a personal computer or other computer terminal) and send the data via the Internet to the computer server.

The data set is then received, at 130. The data set can then be analyzed, parsed, or otherwise verified or validated (e.g., to ensure proper formatting, proper contents, etc.), at 140. If the data set is not verified, for example, because the data set includes data other than the requested data, the data set can be discarded and the data can be requested again, at 120. If the data set is verified, the data set can be associated with the digital document, at 150. For example, the data set can be inserted into a data field (or other portion) of the digital document or stored within a portion of a database related to a portion or data field of the digital document.

The digital document is analyzed or parsed, at 160, to determine whether the digital document is complete. In other words, the digital document is analyzed to determine whether the digital document includes portions or data fields that can be filled or populated with additional data or data sets. If the data fields of the digital document are not populated, process 100 can return to step 120, and additional data can be requested. Steps 120, 130, 140, 150 and 160 can be repeated until all the data fields of the digital document are populated.

If the data fields of the digital document are populated, the digital document can be considered complete, and access information related to a digital signature module can be sent or provided, at 170. For example, a telephone number or universal resource identifier (“URI”) such as a uniform resource locator (“URL”) or Internet address of a digital signature module (or an interface of a digital signature module such as an interactive voice response (“IVR”) system) can be provided to a user of a webpage. As discussed in more detail herein, the access information can be used to provide data associated with a digital signature to the digital signature module.

In some embodiments, process 100 can include more or fewer steps than illustrated in FIG. 1. In some embodiments, some steps may occur in a different order, for example, to account for added steps, pre- or post-processing, etc. For example, step 140 can be removed and/or combined with step 160 such that data sets are verified when the digital document is analyzed to determine whether the digital document is complete. If any of the data sets are not verified, those data sets can be discarded, and process 100 can return to step 120 to request the data related to the data fields for which data sets were discarded. Similarly, step 160 can be removed, and data for all the data fields in the digital document can be requested in one request at step 120. Accordingly, multiple data sets can be received at step 130.

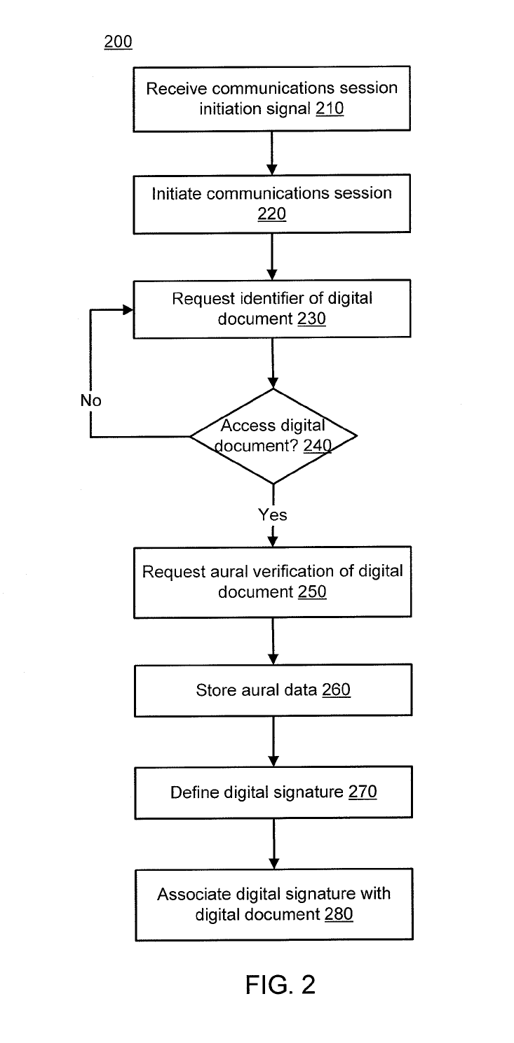

FIG. 2 is a flow chart of a process for defining a digital signature related to a digital document, according to an embodiment. Process 200 can be implemented, for example, as a software module (e.g., source code, object code, one or more scripts, or instructions) stored at a memory and operable to be executed and/or interpreted or compiled at a processor operatively coupled to the memory at a computing device. For example, processor-executable instructions stored at a memory of a computing device can be executed at a processor at the computing device to cause the processor to execute the steps of process 200. In some embodiments, process 200 can be implemented as one or more hardware modules such as, for example, an ASIC, a FPGA, a processor, or other hardware module at a computing device. In some embodiments, process 200 can be implemented as a combination of one or more hardware modules and software modules at a computing device. In some embodiments, an apparatus implementing process 200 can be referred to as a digital signature module.

A communications session initiation signal is received, at 210. A communications session can be, for example, an aural communication session such as a telephonic communications session (such as a telephone call over a public switched telephone network (“PSTN”)), a voice over Internet protocol (“VoIP”) communications session, or some other aural communications session (such as a voice and/or video chat session via a data communications network). A communications session initiation signal can be any signal (e.g., data packet, electrical or electromagnetic pulse, etc.) that provides an indication that a communications session can be initiated. A communications session is initiated in response to the communications session initiation signal, at 220. For example, a telephone call via a telephony network or a VoIP call can be initiated.

An identifier of a digital document is requested, at 230. The identifier can be, for example, an alphanumeric identifier of a digital document that can be entered at a user station, e.g. by entering the identifier via a keypad of a communications device (such as a telephone) or a computing device (such as a computer terminal) and/or by speaking the identifier. For example, process 200 can be implemented at a digital signature module including an IVR system and a user of the digital signature module can communicate with the digital signature module via a telephone. The user can enter the identifier of a digital document to be signed at a keypad of the telephone. The digital signature module can determine (e.g., using a dual-tone multi-frequency decoder) alphanumeric characters of the identifier entered at the keypad of the telephone to receive the identifier of the digital signature module.

In some embodiments, the user can enter or provide additional information to the IVR system (e.g., at the request of the IVR system to confirm the identity of the user) before the digital document can be accessed. For example, the IVR system can prompt the user to enter the user's ZIP code, telephone number, address, and/or some other information. In some embodiments, the IVR system can access a telephone number from which the user is calling using a caller identification system and access the digital document if the user is calling from a telephone number related to or associated with the digital document. In some embodiments, information such as a ZIP code, telephone number, address, and/or other information can be used in combination with a digital document identifier to select or access a digital document. For example, one telephone number of ZIP code can be associated with a group of digital documents, and a digital document identifier can be used to select one digital document (or a subset of digital documents) from the group of digital documents.

The digital document can be accessed based on the digital document identifier, at 240. In other words, the digital document identifier can be used to located and/or access the digital document in, for example, a database of digital documents. If the digital document is not accessed, for example because an incorrect or invalid digital document identifier was received, the request for the digital document identifier, at 230, can be repeated. If the digital document is accessed, aural verification of the digital document can be requested, at 250. For example, aural verification that the digital document is complete, that an individual agrees to the terms of the digital document, that the digital document contains accurate information, and/or other verification of the digital document can be requested. The aural verification need not be limited to spoken responses from the user. For example, the IVR system can pose some questions that solicit a spoken response (e.g. “Please state your name”) and other questions that solicit a non-spoken response, such as input from a keyboard (“Are you John Smith? Please press 1 for yes, 2 for no”).

Aural data (e.g. spoken responses and, optionally, non-spoken responses) associated with the verification can be received and stored, at 260, and a digital signature based on the stored aural data can be defined, at 270. The digital signature can be, for example, a recording of the aural data, a compressed version of the aural data, an encrypted version of the aural data, a representation of a histogram of the aural data, and/or some other digital signature based on the aural data.

The digital signature can then be associated with the digital document, at 280. For example, the digital signature can be stored at a portion of a database that is related to or associated with the digital document. In some embodiments, the digital signature can be attached to or included within the digital document. For example, the digital document can include a data field into which the digital signature can be added. In some embodiments, the digital signature can be sent (e.g., via a communications network) to a third party, and the third party can associate the digital signature with the digital document based on, for example, an identifier of the digital document sent with the digital signature.

A digital document, a digital signature, and/or data related to a digital document or a digital signature can be stored at a single storage system or at different storage systems. For example, a completed or filled-in digital document (e.g., a PDF file) can be stored at a storage system and a digital signature (e.g., an audio file) can be stored at that storage system or a different storage system, and the digital document and the digital signature can be related by, for example, metadata associated with the digital document and/or digital signature, one or more entries in a database, and/or one or more file systems. In some embodiments, data related to a digital document (e.g., data used to generate a PDF file) can be stored separately from the digital document and/or digital signature (e.g., at a database or a file system) locally or remotely (e.g., at a storage facility or a distributed storage service such as Internet or “cloud” storage) and submitted to a third part in real-time (e.g., transmitted as it is received from a user) or submitted with data related to other digital documents in a batch transfer (e.g., data associated with multiple digital documents are transmitted at substantially the same time). In some embodiments, a digital document, data related to that digital document, and/or a digital signature can be stored together (e.g., at a database or within a file system structure such as a directory or file) and encrypted and/or digested (e.g., hashed) using a hash function or algorithm such as MD5 or SHA.

In some embodiments, process 200 can include more or fewer steps than illustrated in FIG. 2. In some embodiments, some steps may occur in a different order, for example, to account for added steps, pre- or post-processing, etc. For example, step 210 can be removed and step 220 can include sending a communication session initiation signal. In other words, although process 200 is described above as initiating an incoming communications session, process 200 can be modified to initiate an outgoing communications session. In some embodiments, process 200 can include additional steps for providing notices and/or various disclosures related to a digital document and/or signing a digital document. For example, if the digital document is an application for insurance, process 200 can include additional steps for providing information related to insurance coverage, premium costs, deductibles, and/or other information as required law or other regulation.

In some embodiments, multiple aural verifications can be requested and stored, and additional digital signature can be defined based on the multiple aural verifications. For example, two individuals or entities may provide aural verification to define two digital signatures for a digital document. Similarly, multiple digital documents can each be signed with a single or multiple digital signatures. For example, some insurance applications include several forms which each should be signed. For example, based on state laws and regulations, a Medicare supplement application may include an application, a Health Insurance Portability and Accountability Act (“HIPAA”) authorization form, a replacement form, a disclosure form, and an electronic funds transfer (“EFT”) form. In addition, a user or consumer may be required (e.g., by law or regulation) to receive and/or respond to certain questions or inquiries regarding an application and/or application process. For example, a user or consumer can be questioned (e.g., by an IVR system) and/or provide responses (e.g., verbally agree that they have received) related to a particular document such as the 2009 Guide to Health Insurance and an Outline of Coverage. When the user calls in and provides the code (e.g., an identifier related to an application) given to him or her at the end of the application process, that call can be associated with a particular group of digital documents associated with an application and an IVR system can handle all of the appropriate signatures (e.g., digital signature) and/or responses (e.g., disclosures and/or additional questions). In some embodiments, an IVR system can additionally present questions to the user regarding health of the user and/or other questions relevant to underwriting, and/or confirm prior responses.

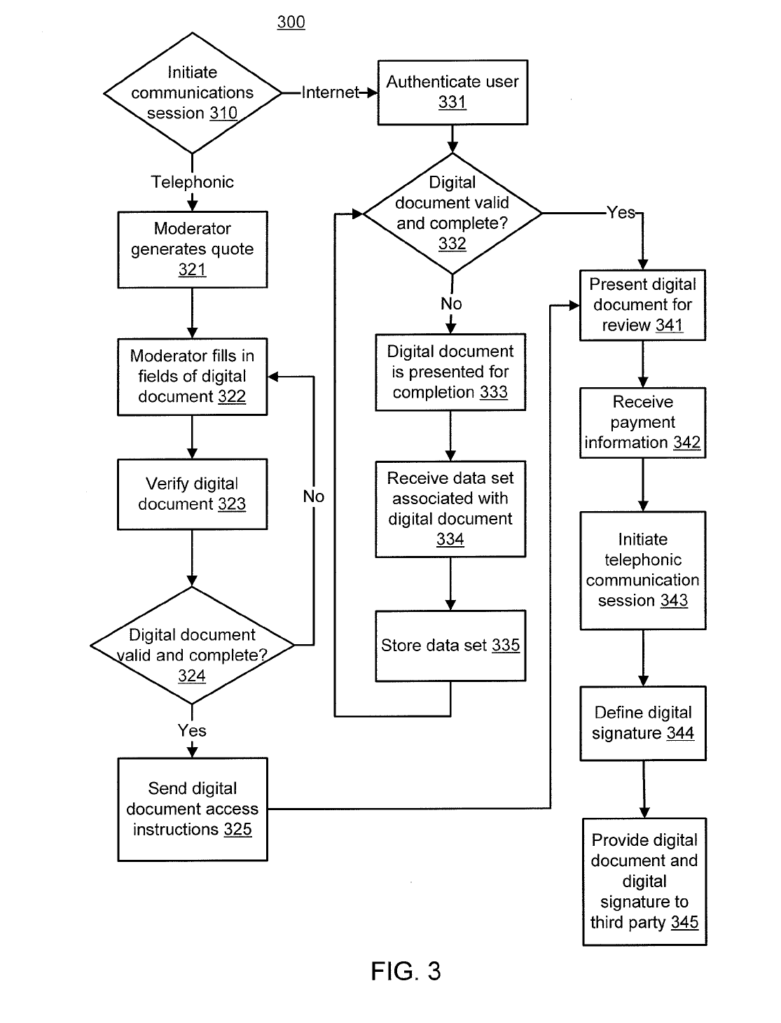

FIG. 3 is a flow chart of a process for digitally signing a digital document, according to an embodiment. Process 300 can be implemented, for example, as a software module (e.g., source code, object code, one or more scripts, or instructions) stored at a memory and operable to be executed and/or interpreted or compiled at a processor operatively coupled to the memory at a computing device. For example, processor-executable instructions stored at a memory of a computing device can be executed at a processor at the computing device to cause the processor to execute the steps of process 300. In some embodiments, process 300 can be implemented as one or more hardware modules such as, for example, an ASIC, a FPGA, a processor, or other hardware module at a computing device. In some embodiments, process 300 can be implemented as a combination of one or more hardware modules and software modules at a computing device.

A communications session is initiated, at 310. For example, a communications session can be an aural communications session initiated in response to, for example, a telephone call. In some embodiments, a communications session can include an interactive website or webpage accessible via the Internet. In some embodiments, a communications session can be a hybrid of a telephonic communications session and a communications session based on an interactive webpage.

If the communications session initiated, at 310, is an aural communications session, a moderator (e.g., an agent, an operator, or other individual) can generate a quote or other data related to an offering such as, for example, an insurance policy, at 321. The moderator can communicate the quote or other data to an individual via the communications session. The moderator can then request information related to data fields of a digital document from the individual, and input data sets into the digital document based on response from the individual. For example, the moderator can request information related to a name, an address, an age, medical history, and/or other information about the individual.

After the data fields of the digital document are filled in or populated, the digital document can be verified or validated, at 323. In other words, the moderator can verify that the data sets populating the data fields of the digital document are valid (e.g., include appropriate data for each data field) and that all the data fields of the digital document have been populated or completed. Said differently, the moderator can verify that the digital document is complete. In some embodiments, the moderator can provide the digital document to a software module such as an application program configured to validate the digital document and the data sets populating the fields of the digital document. If the digital document includes data sets in data fields that are invalid or the digital document is not complete (e.g., data fields are not populated), process 300 can return to step 322, and the moderator can fill in missing, incorrect, or invalid data.

If the digital document is valid and complete, at 324, access instructions or information related to the digital document can be sent to the individual, at 325. For example, a URI can be communicated orally by the moderator to the individual via the telephonic communications session. In some embodiments, the access instructions or information can be sent via electronic mail (“email”) or a letter including the access instructions or information can be mailed to the individual. The access instructions or information can include, for example, a URI of a webpage accessible to the individual via which the individual can review the digital document, at 341. In some embodiments, the access instructions or information can include a user name, a password, an encryption key, and/or an identifier of the digital document that the individual can use to access the digital document. For example, the digital document can be available based a user name and a password or an identifier of the digital document at a webpage. In some embodiments, the digital document can be encrypted and the individual can use the encryption key to decrypt the digital document.

After the individual has reviewed the digital document, the individual can provide payment information, at 342. In some embodiments, the telephonic communications session can be ongoing and the payment information can be provided to the moderator. In some embodiments, the individual can enter the payment information at a portion of a webpage after reviewing the digital document. After the payment information is received, at 342, a telephonic communications session with the individual can be initiated, at 343. For example, the individual can be provided with access information associated with a digital signature module, and the individual can access the digital signature module as discussed above. In other words, the individual can be provided with, for example, a telephone number of an IVR system and can place a telephone call to the IVR system. Alternatively, a telephone number of the individual can be provided to an IVR system and the IVR system can place a telephone call to the individual.

A digital signature can be defined, at 344, for example, as discussed above with respect to FIG. 2. The digital document and digital signature can then be stored and/or provided to a third party, at 345. For example, the digital document and/or digital signature can be transmitted to the third party. In some embodiments, the digital document and/or digital signature can be made accessible to the third party. For example, the digital document and/or digital signature can be stored at a file server such as a file transfer protocol (“FTP”) server that is accessible to the third party. In some embodiments, the digital document and/or digital signature can be stored locally at a file server. In some embodiments, the digital document and/or digital signature can be stored remotely with respect to a file server (e.g., at a computer server or a distributed storage service such as an Internet or “cloud” storage service accessible via a communications network to the file server). In some embodiments, the digital document and/or digital signature is not provided to the third party. Rather, a signal indicating that a particular digital document has been digitally signed is sent to the third party. In other words, the third party can be notified that a digital document has been digitally signed, and the digital document and digital signature can be stored or archived.

Returning now to step 310, if the communications session initiated, at 310, is an Internet communications session (e.g., webpage-based communications session), the user of the webpage (e.g., an individual that will provide information for a digital document) can be authenticated, at 331. For example, the user can provide a user name and password associated with that user or a user account. In some embodiments, additional verification questions or challenges are presented to the user during authentication. For example, an address, telephone number, and/or some other information related to a digital document can be provided by the user for authentication. In some embodiments, the user can create a user name and a password (or other identifiers) that can be used to access a website including webpages configured to provide an interface for providing information to a digital document. In some embodiments, the user is not authenticated and can freely select a digital document for which the user will provide information.

The digital document can be analyzed or parsed, at 332, to determine whether the digital document is complete. For example, a user can have previously populated some or all fields of a digital document, and has authenticated or logged onto a website or webpage to complete the digital document. As discussed above, a digital document can be complete if the data fields of the digital document are populated with data sets that are valid for those data fields. If the digital document is complete, the user can review the digital document, as discussed above beginning at step 341. If the digital document is not complete, the digital document can be presented to the user for completion, at step 333. For example, a webpage defined based on the digital document can be presented to the user. The webpage can include data fields of the digital document into which the user can input or enter information or data sets. In some embodiments, a series or sequence of webpages associated with one or more data fields of the digital document can be presented to the user, and the user can input information related to the digital document via the webpages.

In some embodiments, the digital document can be provided by a third party and the user can input information or data sets into data fields of the digital document directly. For example, the digital document can be an insurance policy application that has been approved by a regulatory body in a PDF format. The data fields of the digital document can be accessible to the user such that the user can edit the data fields (e.g., via an Internet browser, via an Internet browser plug-in, or via an application program), and send the digital document to a computer server implementing process 300.

The data set or data sets associated with the data fields of the digital document (or the digital document itself, can be received, at 334, and stored, at 335. The digital document can be analyzed or parsed, at 332, to determine whether the digital document is complete. As discussed above, if the digital document is complete, the user can review the digital document, as discussed above beginning at step 341. If the digital document is not complete, the digital document can be presented to the user for completion, at step 333.

In some embodiments, process 300 can include more or fewer steps than illustrated in FIG. 3. In some embodiments, some steps may occur in a different order, for example, to account for added steps, pre- or post-processing, etc. For example, in some embodiments a moderator can transfer a telephonic communications session to an IVR system after, for example, step 342. In some embodiments, a moderator can remain in a telephonic communications session while the individual interacts with an IVR system (e.g., the telephonic communications session can be conference including the individual, the moderator, and the IVR system). In some embodiments, payment information can be provided before the digital document is accessed and/or as part of a validation process. In other words, payment information can be requested as an initial step and used to validate (e.g., verify an identity) of a user.

In some embodiments, the moderator can be a person following a script provided by a software module such as an application program. In some embodiments, the moderator can be an IVR system.

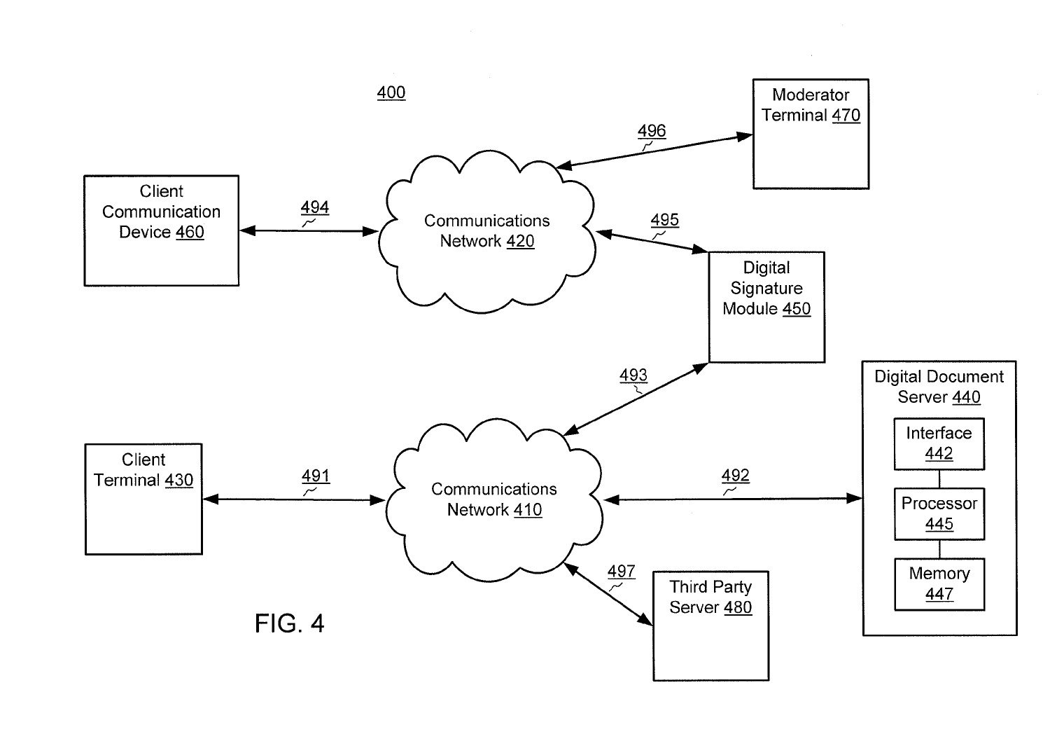

FIG. 4 is a schematic block diagram of system 400 for accessing and digitally signing a digital document, according to an embodiment. System 400 includes digital document server 440 configured to provide access to digital documents to client terminal 430 via communications network 410. Digital document server 440 can be any device configurable to receive requests for access to digital documents from and/or send or provide access to digital documents to client terminal 430. For example, a digital document server can be a web server, a file server, a network attached storage device (“NAS”), a storage area network device (“SAN”), a database server, or a multimedia server. In some embodiments, a digital document server can have multiple interfaces such that it is accessible as one or more of a web server, a file server, a network attached storage device (“NAS”), a storage area network device (“SAN”), a database server, and/or a multimedia server. Client terminal 430 can be any device configurable to request and/or receive access to (or provide data sets to) digital documents at digital document server 440. For example, client terminal 430 can be a personal computer running a web browsing application, a file transfer application, a database application, and/or a multimedia application.

Digital signature module 450 can be any device configured to define a digital signature. For example, digital signature module 450 can be an IVR system. As illustrated in FIG. 4, digital signal module 450 is in communication with communications network 410 and communications network 420. In other words, digital signal module 450 can communicate via communications network 410 and communications network 420.

Third party server 480 can be any device configurable to receive a one or more digital documents from digital document server 440, one or more digital signatures from digital signature module 450, and/or one or more signals from digital signature module 450 and/or digital document server 440 indicating that a digital document has been signed. As illustrated in FIG. 4, third party server 480 is in communication with communications network 410.

Communications network 410 can be any communications network configurable to allow digital document server 440, client terminal 430, third party server 480, and/or digital signature module 450 to communicate with communications network 410 and/or to each other through communications network 410. Communications network 410 can be any network or combination of networks capable of transmitting information (e.g., data and/or signals) and include, for example, a telephone network, an Ethernet network, a fiber-optic network, a wireless network, and/or a cellular network.

In some embodiments, communications network 410 can include multiple networks operatively coupled one to another by, for example, network bridges, routers, switches and/or gateways. For example, client terminal 430 can be operatively coupled to a cellular network and digital document server 440 can be operatively coupled to a fiber-optic network. The cellular network and fiber-optic network can each be operatively coupled one to another via one or more network bridges, routers, switches, and/or gateways such that the cellular network, the Ethernet network and the fiber-optic network are operatively coupled to form a communications network. Alternatively, the cellular network and fiber-optic network can each be operatively coupled one to another via one or more additional networks. For example, the cellular network and the fiber-optic network can each be operatively coupled to the Internet such that the cellular network, the fiber-optic network and the Internet are operatively coupled to form a communications network.

As illustrated in FIG. 4, digital document server 440 is operatively coupled to communications network 410 via network connection 492; client terminal 430 is operatively coupled to communications network 410 via network connection 491; third party server 480 is operatively coupled to communications network 410 via network connection 497; and digital signature module 450 is operatively coupled to communications network 410 via network connection 493. Network connections 491, 492, 493 and 497 can be any appropriate network connection for operatively coupling digital document server 440, client terminal 430, third party server 480 and digital signature module 450 to communications network 410.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a cable connection such as, for example, an Ethernet connection, a digital subscription line (“DSL”) connection, a broadband coaxial connection, and/or a fiber-optic connection.

In some embodiments, a system can include more than one client terminal, more than one third party server, more than one digital signature module, and/or more than one digital document server. Thus, for example, a client terminal can access digital documents at more than one digital document server and a digital document server can provide access to digital documents to more than one client terminal. In some embodiments, a first client terminal, a client second terminal and/or digital document server can be operatively coupled to a communications network by heterogeneous network connections. For example, a client terminal can be operatively coupled to the communications network by a WWAN network connection, another client terminal can be operatively coupled to the communications network by a DSL network connection, and a digital document server can be operatively coupled to the communications network by a fiber-optic network connection.

As illustrated in FIG. 4, digital document server 440 includes processor 445, interface 442 and memory 447. Digital document server 440 is operatively coupled to communications network 410 via interface 442 and network connection 492. Interface 442 can be any interface configurable to be operatively coupled to communications network 410 via network connection 492. For example, an interface can be a wireless interface such as, for example, a worldwide interoperability for microwave access (“WiMAX”) interface, a high-speed packet access (“HSPA”) interface, and/or a WLAN interface. An interface can also be, for example, an Ethernet interface, a broadband interface, a fiber-optic interface, and/or a telephony interface.

Processor 445 is operatively coupled to interface 442 such that processor 445 can be configured to be in communication with communications network 410 via interface 442. Processor 445 can be any of a variety of processors. Such processors can be implemented, for example, as hardware modules such as embedded microprocessors, microprocessors as part of a computer system, Application-Specific Integrated Circuits (“ASICs”), and Programmable Logic Devices (“PLDs”). Some such processors can have multiple instruction executing units or cores. Such processors can also be implemented as one or more software modules in programming languages as Java™, C++, C, assembly, a hardware description language, or any other suitable programming language. A processor according to some embodiments includes media and computer code (also can be referred to as code) specially designed and constructed for the specific purpose or purposes.

In some embodiments, a server can be a virtual device implemented in software such as, for example, a virtual machine executing on or in a processor. For example, a server can be a software module executing in a virtual machine environment such as, for example, a Java™ module executing in a Java™ Virtual Machine (“JVM”), or an operating system executing in a VMware™ virtual machine. In some such embodiments, a network interface, a processor, and a memory can be virtualized and implemented in software executing in, or as part of, a virtual machine.

Processor 442 is also operatively coupled to memory 447. Memory 447 can be a read-only memory (“ROM”); a random-access memory (“RAM”) such as, for example, a magnetic disk drive, and/or solid-state RAM such as static RAM (“SRAM”) or dynamic RAM (“DRAM”); and/or FLASH memory or a solid-data disk (“SSD”). In some embodiments, a memory can be a combination of memories. For example, a memory can include a DRAM cache coupled to a magnetic disk drive and an SSD.

In addition to memory 447, some embodiments include another processor-readable medium, for example a database accessible to digital document server 440, (not shown in FIG. 4) having instructions or computer code thereon for performing various processor-implemented operations including, for example, signing and verifying digital documents. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as floptical disks; solid-state memory such as SSDs and FLASH memory; and ROM and RAM devices. Examples of computer code include, but are not limited to, micro-code or micro-instructions, machine instructions (such as produced by a compiler), and files containing higher-level instructions that are executed by a computer using an interpreter. For example, an embodiment may be implemented using Java™, C++, or other object-oriented programming language and development tools. Additional examples of computer code include, but are not limited to, control signals, encrypted code, and compressed code.

In some embodiments, client terminal 430, third party server 480, and/or digital signature module 450 also each include an interface, a processor and a memory. For example, a personal computer terminal and a portable or handheld device, such as a cellular telephone device or portable/mobile internet device, can include an interface, a processor and a memory.

As illustrated in FIG. 4, system 400 also includes client communication device 460, communications network 420, and moderator terminal 470. Communications network 420 can be a separate communications network from communications network 420. For example, communications network 420 can be a telephony network such as a PSTN. Client communication device 460, moderator terminal 470, and digital signature module 450 are each in communication with communications network 420 via network connection 494, network connection 496, and network connection 495, respectively. Additionally, client communication device 460, moderator terminal 470, and/or digital signature module 450 can communicate (e.g., exchange signals related to aural data and/or other data) via communications network 420. Network connection 494, network connection 496, and network connection 495 can be, for example, telephone lines, wireless telephone connections, and/or cellular connections operatively coupled to or in communication with communications network 420. In some embodiments, moderator terminal 470 is operatively coupled to communications network 420 and communications network 410.

Client communication device 460 can be a device configured to communicate with moderator terminal 470 and/or digital signature module 450 via communications network 420. Client communication device 460 can be, for example, a telephone, a wireless telephone, a cellular telephone, or some other communication device. Similarly, moderator terminal 470 can be, for example, a telephone, a wireless telephone, a cellular telephone, or some other communication device configured to communicate with client communication device and/or digital signature module 450 via communications network 420. As discussed above, digital signature module 450 can be a device or apparatus configured to communicate aurally with a user or client via communications network 420. For example, digital signature module 450 can include an IVR system or module with a voice or vocal processing module configured to produce aural signals such as words via communications network 420, and receive and record (or store) aural signals or data to define a digital signature.

A client (e.g., a user of system 400) can access a webpage provided at digital document server 440 via communications network 410. For example, client terminal or user station 430 can include an Internet browser configured to access the webpage. Concurrently, the client can connect with (e.g., place a telephone call to) a moderator at moderator terminal 470 via communications network 420 using client communication device 460 (e.g., a telephone). Using client terminal 430 and the webpage, the client can complete a digital document hosted (or accessible or stored) at digital document server 440. In other words, the client can enter or insert information (or data sets) into data fields of the digital document. The client can ask for clarification regarding data fields and/or other portions of the digital document from the moderator using client communication device 460.

After the digital document is complete, the client can review the digital document using client terminal 430 to ensure that the information (or data sets) at the data fields of the digital document are correct (e.g., contain accurate information). In some embodiments, digital document server 440 can also validate the digital document based on, for example, rules or parameters associated with the digital document and/or data sets stored at data fields of the digital document. Digital document server 440 can then send a telephone number related to digital signature module 450 to client terminal 430. Additionally, digital document server 440 can send the digital document (or data or metadata related to the digital document) to digital signature module 450 (or provide digital signature module 450 with access to the digital document). In some embodiments, digital document server 440 can also provide one or more URIs to client terminal 430, and client terminal 430 can use the URI(s) to access the digital document at digital document module 450 and/or to access the digital signature module. In some embodiments, digital document server 440 can provide the digital document to the client via, for example, email or some other mail system. In some embodiments, a digital document, data related to a digital document, and/or a digital signature can be stored locally at a memory of a digital document server, at a database (not shown in FIG. 4) accessible to a digital document server via a communications network, and/or at a distributed storage service (not shown in FIG. 4) such as an Internet or “cloud” storage service.

The client can then access-digital signature module 450 via communications network 420 using client communication device 460. For example, digital signature module 450 can provide an IVR interface accessible via communications network 420. In some embodiments, the client can use client communication device 460 to end a telephone call with the moderator, and initiate a telephone call to an IVR interface of digital signature module 450. In some embodiments, the moderator can transfer the client (e.g., the telephone call or session with the client) to the IVR interface of digital signature module 450. In some embodiments, the moderator can establish a conference call including the client, the moderator, and the IVR interface of digital signature module 450.

Digital signature module 450 can interact aurally with the client via communications network 420 and client communication device 460. For example, digital signature module can request an aural indication that the client assents to the terms and conditions of the digital document and that the client asserts that the information entered into the data fields of the digital document are accurate. This aural indication can be (or be used to define) a digital signature. In some embodiments, digital signature module 450 can request that the client access and review the digital document (e.g., using an URI provided to the client by digital document server 440).

In some embodiments, digital signature module 450 can ask questions of the client to gather additional information for the digital document. In some embodiments, digital signature module 450 can provide one or more messages or disclosures to the client. In some embodiments, the messages or disclosures provided to the client and/or the questions asked of the client by digital signature module 450 can vary based on the digital document (e.g., a type of class of a digital document) and/or information at one or more data fields of the digital document. For example, digital signature module 450 can ask one set of questions (or provide one message) if a client is within one age range, and another set of questions (or provide another message) if the client is within another age range. Similarly, if the digital document is an insurance application, digital signature module 450 can ask one set of questions (or provide one message) if the digital document is for one insurance carrier, and another set of questions (or provide another message) if the digital document is for another insurance carrier.

After a digital signature (e.g., a voice recording) has been defined at digital signature module 450, the digital document and/or the digital signature can be provided to third party server 480 by digital signature module 450 and/or digital document server. The third party can be, for example, an insurance carrier and the digital document can be an application for insurance with that insurance carrier. In some embodiments, portions of the digital document such as, for example, data sets entered into data fields of the digital document are sent, rather than the digital document. In other words, the information entered by the client can be referred to as a digital document and sent to third party server 480. For example, an XML document including identifiers of data fields and the data sets entered into those data fields by the client can be the digital document sent to third party server 480. In other embodiments, an image of the digital document can be sent to third party server 480. For example, the digital document can be digitally printed as a PDF file, and the PDF file can be sent to third party server 480. In some embodiments, the PDF file can be stored locally (e.g., at a memory or database accessible to digital document server 440) or remotely, for example, at a database accessible to digital document server 440 via a communications network and/or at a distributed storage service such as an Internet or “cloud” storage service. In other words, a digital document (and/or related data such as a digital signature) can be stored by a digital document server rather than transmitted to a third party.

Third party server 480 can receive the digital document and digital signature and provide further processing to process the digital document. For example, third party server 480 can perform optical character recognition to produce a computer-readable version of the digital document. In some embodiments, third party server 480 can send the digital document and/or signature to an agent to review.

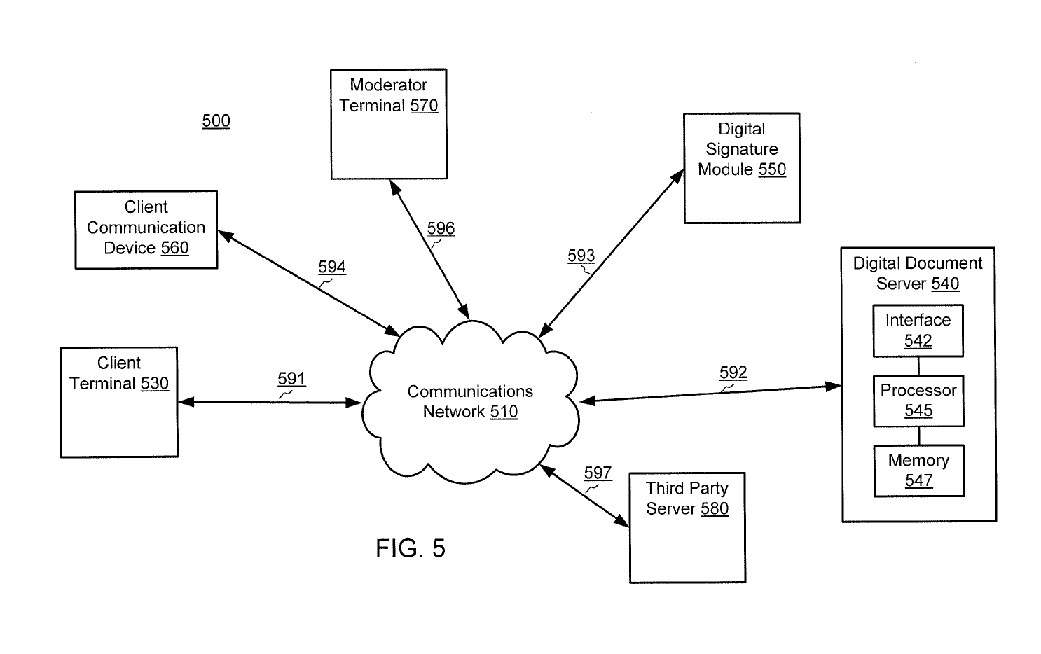

FIG. 5 is a schematic block diagram of system 500 for accessing and digitally signing a digital document, according to an embodiment. As illustrated in FIG. 5, a client terminal, a moderator terminal, a digital signature module, a digital document server, and/or a third party server can be operatively coupled to and in communication with a common communications network. In some embodiments, a client communication device can also be operatively coupled to and in communication with the common communications network.

Client terminal 530, client communication device 560, moderator terminal 570, digital signature module 550, digital document server 540, and third party server 580 (generically referred to as system devices) are operatively coupled to communications network 510 via network connections 591, 594, 596, 593, 592 and 597, respectively. Client terminal 530, client communication device 560, moderator terminal 570, digital signature module 550, digital document server 540, and third party server 580 are configured to communicate one with another via communications network 510. In other words, a single communications network can enable one or more client terminals, client communication devices, moderator terminals, digital signature modules, digital document servers, and/or third party servers to communicate.

For example, rather than exchanging data sets related to fields of a digital document via one communications network and aural data via another communications network, both types or classes of data can be exchanged (or communicated) via a single communications network. For example, communications network 510 can be an Internet protocol (“IP”) network, and client communication device 560, moderator terminal 570, and digital signature module 550 can be VoIP devices (or include VoIP) modules such that aural data can be exchanged among client communication device 560, moderator terminal 570, and digital signature module 550 via communications network 510.

Similar to the digital document server 440 discussed in relation to FIG. 4, digital document server 540 (and the other system elements of system 500) can include an interface for communicating with communications network 510, a processor, and a memory. More specifically, as illustrated in FIG. 5, digital document server includes interface 542 and memory 547 in communication with processor 545.

In some embodiments, multiple, load-balanced digital document servers and/or digital signature modules can be configured to access a shared code-base at a database server via a storage area network (“SAN”) within a private network. In other words, a system can include multiple, redundant digital document servers and/or digital signature modules such that a client terminal can connect to one of the multiple, redundant digital document servers and/or digital signature modules.

While certain embodiments have been shown and described above, various changes in form and details may be made. For example, some features of embodiments that have been described in relation to one embodiment and/or process for digitally signing and/or verifying a digital document can be useful in other embodiments and/or processes. Similarly, some embodiments have been described with reference to insurance plans, forms, and/or applications related to Medicare. Such embodiments can also be applicable to other forms and/or applications, including forms and/or applications related to insurance in general. Furthermore, some embodiments can also be applicable to other types of digital documents to be digitally signed such as contracts. Additionally, some embodiments that have been described in relation to a software implementation can be implemented as digital or analog hardware. For example, a server, personal computer or other terming can include specialized hardware such as one or more accelerator cards and/or chips for digitally signing and/or verifying a digital document.

Furthermore, it should be understood that the systems and methods described herein can include various combinations and/or sub-combinations of the components and/or features of the different embodiments described. For example, steps or methods described in relation to one embodiment of digitally signing or verifying a digital document can be combined with steps or methods described in relation to other embodiments of digitally signing or verifying a digital document. Additionally, in some embodiments, a digital document can include multiple digital documents, each with one or more digital signatures. Similarly, a digital document can be digitally signed by more than one person or entity (e.g., multiple digital signatures from different persons or entities can be associated with the digital document). Thus, features described with reference to one or more embodiments can be combined with other embodiments described herein.

What is claimed is:

1. A method, comprising:
receiving, via a communications network, a data set associated with a digital document stored at a memory, the digital document including a plurality of data fields;
storing at least a portion of the data set at a portion of the memory associated with a data field from the plurality of data fields of the digital document;
verifying that the data field from the plurality of data fields of the digital document is complete; and
sending, via the communications network, access information associated with a digital signature module configured to define a digital signature including aural data.

2. The method of claim 1, wherein:
the access information includes a telephone number.

3. The method of claim 1, wherein:
the access information includes a uniform resource identifier.

4. The method of claim 1, further comprising providing, via the communications network, access to at least a portion of the digital document to a user station.

5. The method of claim 1, further comprising sending, via the communications network, an identifier of the digital document to a user station.

6. The method of claim 1, further comprising, before the sending, receiving from a user station an indication that the data set stored at the data field from the plurality of data fields of the digital document is accurate.

7. The method of claim 1, further comprising, before the receiving the data set:
receiving a request for access to the digital document via the communications network; and
providing a representation of the plurality of data fields of the digital document to a user station via the communications network in response to the request for access to the digital document.

8. The method of claim 1, further comprising, before the receiving the data set, sending to a user station a request for the data set.

9. The method of claim 1, further comprising, before the receiving the data set, requesting the data set via an aural communication session.

10. The method of claim 9, wherein the aural communication session is one of a telephonic communication session via a public switch telephone network, a VoIP communication session via a data network, or a voice or video chat session via a data network.

11. The method of claim 9, wherein the user station is one of a telephone and a computer terminal.

12. The method of claim 1, further comprising:
before the receiving the data set, requesting the data set via a first telephonic communication session; and
providing a second telephonic communication session in communication with the first telephonic communication session.

13. The method of claim 1, wherein:
the data set associated with the digital document stored is received via the communications network from a moderator terminal; and
the access information associated with the digital signature module is sent via the communications network to a user station.

14. A method, comprising:
receiving, at a digital signature module, an initiation signal associated with an aural communication session;
storing aural data received via the aural communication session at a memory accessible to the digital signature module;
defining a digital signature based on the aural data; and
associating the digital signature with an identifier of a digital document.

15. The method of claim 14, further comprising receiving the identifier of the digital document via the aural communication session.

16. The method of claim 14, further comprising:
terminating the aural communication session; and
after the terminating, sending the digital document and the digital signature to a computing device via a communications network.

17. The method of claim 14, further comprising, before the storing the aural data, providing via a communications network access to at least a portion of the digital document to a user station.

18. The method of claim 14, further comprising, before the storing the aural data, receiving from a user station an indication that a data set stored at a data field from a plurality of data fields of the digital document is accurate.

19. The method of claim 18, wherein the user station is one of a telephone and a computer terminal.

20. The method of claim 14, further comprising, before the receiving the aural data, requesting the aural data via the aural communication session.

21. The method of claim 14, wherein the aural communication session is a first aural communication session, the method further comprising:
before the receiving the aural data, requesting the aural data via the first aural communication session; and
providing a second aural communication session in communication with the first aural communication session.

22. The method of claim 14, wherein the aural communication session is one of a telephonic communication session via a public switch telephone network, a VoIP communication session via a data network, or a voice or video chat session via a data network.

23. The method of claim 14, wherein the aural data includes at least one user spoken response to at least one request for the aural data.

24. The method of claim 14, wherein the aural data includes at least one user non-spoken response to at least one request for the aural data.

25. A processor-readable medium storing code representing instructions that when executed by a processor cause the processor to:
initiate a telephonic communication session in response to an initiation signal received via a aural communications interface in communication with the processor;
receive aural data via the aural communications interface in communication with the processor;
define a digital signature based on the aural data; and
associate the digital signature with an identifier of a digital document.

26. The processor-readable medium of claim 25, wherein the aural communication session is a first aural communication session and the aural communication interface is a first aural communication interface, the processor-readable medium further storing code representing instructions that when executed by the processor cause the processor to:
request, via the first aural communication session, the aural data via the first aural communication session; and
initiate a second aural communication session via a second aural communications interface in communication with the processor, the second aural communication session in communication with the first aural communication session.

27. The processor-readable medium of claim 25, further storing code representing instructions that when executed by the processor cause the processor to:
terminate the aural communication session after receiving the aural data; and
send the digital document and the digital signature to a computing device in communication with the processor via a communications network in communication.

28. The processor-readable medium of claim 25, further storing code representing instructions that when executed by the processor cause the processor, before receiving the aural data, to send to a user station via a communications network at least a portion of the digital document.

29. The processor-readable medium of claim 28, wherein the user station is one of a telephone and a computer terminal.

30. The processor-readable medium of claim 25, wherein the aural data includes at least one user spoken response to at least one request for the aural data.
